(19) United States
(12) Patent Application Publication
(10) Pub. No.: US 2012/0171052 A1
(43) Pub. Date: Jul. 5, 2012

(54) MOTOR COMPRESSOR SYSTEM AND METHOD

(76) Inventor: Silvio GIACHETTI, Firenze (IT)

(21) Appl. No.: 13/339,627

(22) Filed: Dec. 29, 2011

(30) Foreign Application Priority Data
Dec. 30, 2010 (IT) MI2010A002466

(51) Int. Cl. F04B 17/00; F04B 49/06; B23P 6/00

(52) U.S. Cl. 417/53; 417/423.15; 29/888.021

(57) ABSTRACT

A motor compressor system in which the motor is configured to activate the compressor. The system includes a common casing; a motor cartridge housing a motor, the motor cartridge detachably provided inside the common casing; and a compressor cartridge housing a compressor detachably connected to the motor, the compressor cartridge detachably provided inside the common casing.

### BACKGROUND

1. Technical Field

Embodiments of the subject matter disclosed herein generally relate to methods and systems and, more particularly, to mechanisms and techniques for efficiently providing a motor and a compressor in a single casing.

2. Discussion of the Background

In the petrochemical industry, booster pumps or compressors may be located at intervals along a liquid-products or gas pipeline to boost the pressure of the flowing gas or liquid to keep it moving toward its destination. Booster pumps or compressors may also be used in other pipelines to move gas or liquid to and through various processes associated with petrochemical exploration, refinement and transport. Examples of a booster compressor are an in-line centrifugal compressor and an axial compressor that are used to move gaseous petrochemicals or byproducts through pipelines. These pipeline boosters can be used upstream (during exploration and production), midstream (during processing, storage and transportation) or downstream (during natural gas/petrochemical refining, transmission and distribution) in a petrochemical process.

To move natural gas or other gases, centrifugal compressors use a rotating disk or impeller in a shaped housing to force the gas to the rim of the impeller, increasing the velocity of the gas. A diffuser (divergent duct) section converts the velocity energy to pressure energy.

In some cases, a standard casing size can house a different number of impellers to optimize performance in terms of efficiency, compression ratio and operating range. Compressor casings can be made of forged steel to maximize material strength and metallurgical stability. Vibration reduction may be provided by bearings positioned at both casing ends. Dry gas seals may be used to prevent gas leakage. Floating bushing oil seals may also be used.

Various motors can be used to drive the booster pumps or compressors, including electric motors, gas turbines or other motors. For example, a booster station may couple a turbine, operating as a gas generator, with a power turbine to drive the booster compressor. Alternatively, an electric motor may be used, especially in pipelines.

As noted above, various industries use a compressor that is driven by an electrical motor. As these two machines are complex and also connected to each other, when parts of the compressor fail or need maintenance, the entire machine needs to be shut down, and the compressor needs to be dissemble piece by piece until the operator reaches the failed part or the part that needs maintenance. This process is tedious and time consuming as a conventional compressor has many parts.

FIG. 1 shows an exploded view of a conventional centrifugal compressor configured to be connected to an external electric motor, not showed in the drawing. Many of the parts of this centrifugal compressor have been removed from the figure for simplicity. Even so, it is noted the amount of parts that need to be assembled/disassembled when maintaining the compressor. The time a plant needs to be stopped for the maintenance or replacement of this type of machine is very long because it is necessary to disassembly the external tubings or connections from the compressor or motor before their removal.

An example of a turbomachine that reduces the assembly/disassembly time comparative with the machine shown in FIG. 1 is the turbomachine assembly 100 having a compressor cartridge 102 and a motor 104 connected to each other as shown in FIGS. 2 and 3. This development includes housing an entire compressor in the compressor cartridge 102 and its electric motor 104 in a corresponding housing 103 that is designed for rapid installation/removal, as shown in FIG. 2. Here, a modular compressor assembly is designed such that the compressor cartridge 102 can be removed/installed in a compressor casing 106. The compressor cartridge 102 includes all the components of the compressor (e.g., impellers, bearings, seals, stationary flow-path components, etc.) within the cartridge. When installed, the modular compressor assembly is connected to the corresponding electric motor 104.

In order to connect or disconnect the compressor cartridge 102 and the electric motor 104, a retractable cover 201 is operated, as shown in FIGS. 3. FIG. 3 shows the retractable cover 201 covering a connection between the compressor cartridge 102 and the motor 104 while FIG. 2 shows the retractable cover 201 retracted to expose a connection 203. A mechanism 205 and 207 is noted for actuating the retractable cover 201.

Accordingly, it would be desirable to provide systems and methods that avoid the afore-described problems and drawbacks.

### SUMMARY

According to one exemplary embodiment, there is a motor compressor system in which the motor is configured to activate the compressor. The system includes a common casing; a motor cartridge housing a motor, the motor cartridge detachably placed inside the common casing; and a compressor cartridge housing a compressor detachably connected to the motor, the compressor cartridge detachably placed inside the common casing.

According to another exemplary embodiment, there is a motor cartridge system that includes a motor cartridge configured to be detachably provided inside a common casing; and a motor housed within the motor cartridge and configured to be detachably connected to a compressor, the compressor configured to compress gas for transport in a gas pipeline.

According to still another exemplary embodiment, there is a motor compressor system in which a motor is configured to activate a compressor. The system includes a common casing; a motor cartridge housing the motor, the motor cartridge detachably provided inside the common casing; a compressor cartridge housing the compressor detachably connected to the motor, the compressor cartridge detachably provided inside the common casing; a mechanical connector connecting a motor shaft of the motor to a compressor shaft of the compressor within the common casing; magnetic bearings provided in the motor around the motor shaft; and a pipe configured to connect a downstream gas supply pipe or an upstream gas supply pipe connected to the common casing to a motor inlet duct of the motor cartridge so as to provide the gas to cool the motor.

According to still another exemplary embodiment, there is a method of repairing a system including a compressor cartridge having a compressor, the system also including a motor cartridge having a motor, the system configured to receive a gas, compress the gas, and eject the compressed gas. The method includes turning off the motor; closing or bypassing a gas flow through the compressor; disconnecting the motor from the compressor by disconnecting a mechanical joint connecting a motor shaft of the motor to a compressor shaft of the compressor; and disconnecting and removing the motor cartridge and/or the compressor cartridge from the common casing. The compressor cartridge and the motor cartridge are provided inside the common casing.

According to yet another exemplary embodiment, there is a method of compressing gas. The method includes receiving the gas into a motor compressor system from a pipeline duct at a first pressure, the motor compressor system including a compressor driven by a motor having magnetic bearings; compressing the gas with the compressor; and ejecting the compressed gas to an output pipeline at a second pressure higher that the first pressure.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a simplified drawing of a related art centrifugal compressor;

FIG. 2 is a schematic diagram of a turbomachine having a centrifugal compressor connected to a motor and having a retractable cover;

FIG. 3 is a schematic diagram of the turbomachine of FIG. 2 and having the retractable cover closed;

FIGS. 4-6 are schematics of an embodiment of the invention;

FIG. 7 is an exemplary embodiment of an above-ground gas compressing station according to an embodiment of the invention;

FIG. 8 is a flow chart according to an embodiment of the invention; and

FIG. 9 is a flow chart according to an embodiment of the invention.

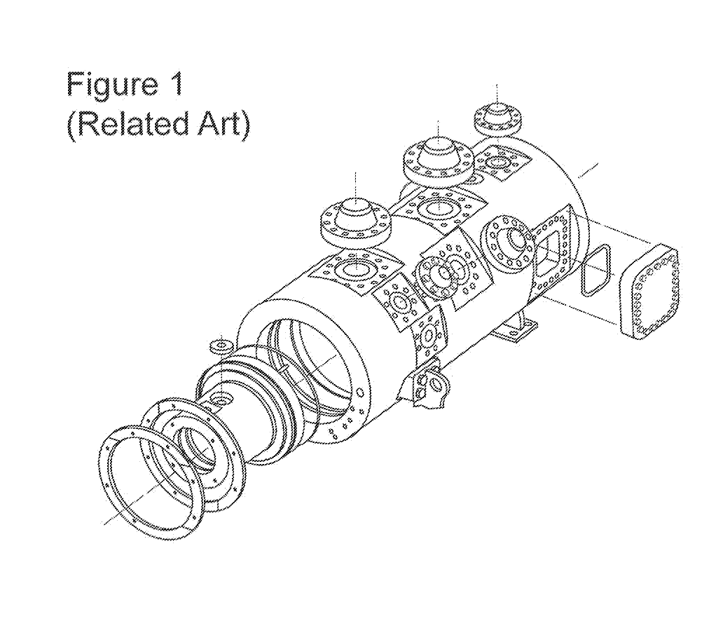

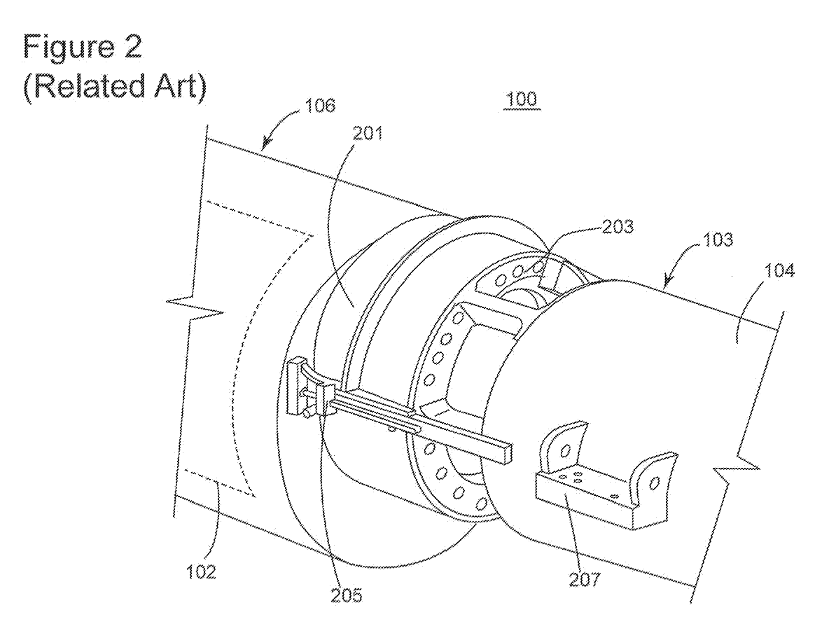

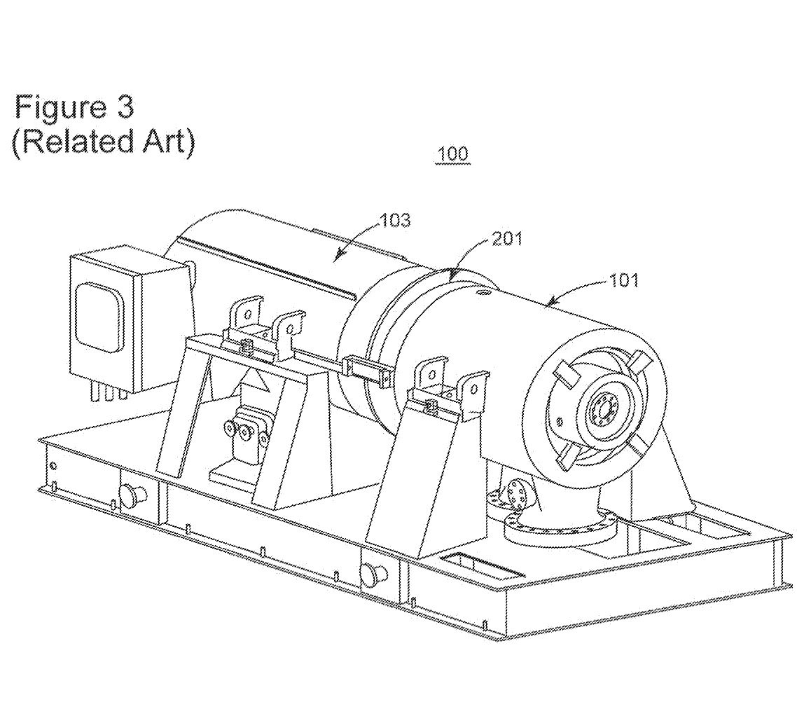

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a permanent magnet compressor and a motor assembly having a common casing. However, the embodiments to be discussed next are not limited to these systems, but may be applied to other systems that combine two machines in a common casing.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, components of a motor are provided in a motor cartridge and components of a compressor are provided in a compressor cartridge to form a machine assembly. The compressor cartridge and the motor cartridge are independently from each other and connected to each other inside a common casing. Thus, when either parts of the motor or the compressor need to be accessed or changed, the entire cartridge including the part may be removed from the common casing and another new cartridge may be slided back into the common casing for a fast restarting of the machine assembly.

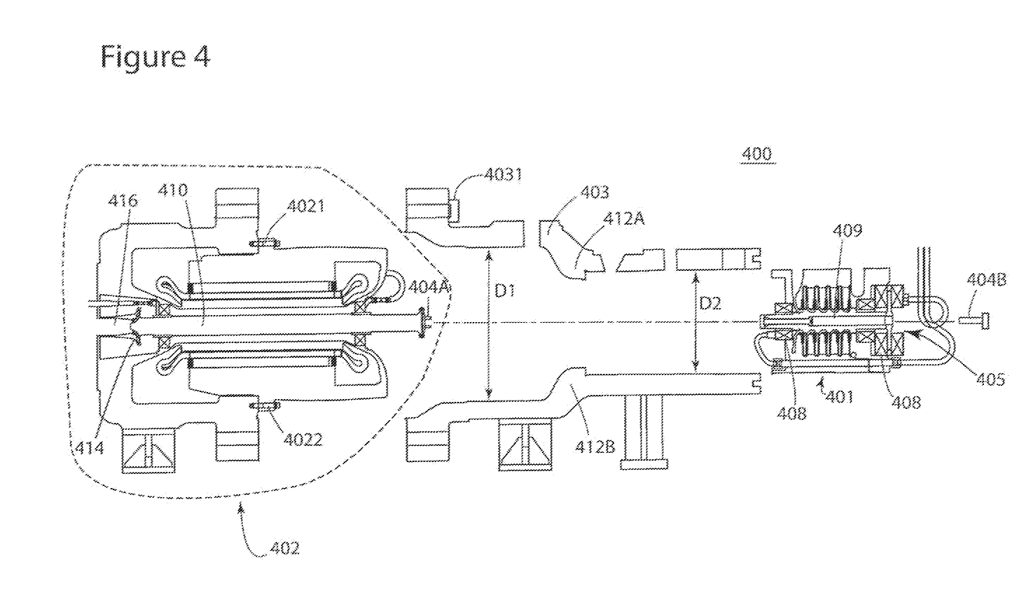

FIG. 4 is a schematic of an embodiment of the invention. FIG. 4 shows a motor-compressor system 400 that includes a self-contained compressor cartridge 401 connectable to a self-contained motor cartridge 402. The compressor cartridge 401 may include a centrifugal compressor 405 and the motor cartridge 402 may include an electrical motor 407. The compressor cartridge 401 and the motor cartridge 402 are each configured to be connected to each other in a common casing 403. In one application, the common casing 403 is made of a single piece. In one application, both the compressor cartridge 401 and the motor cartridge 402 are configured to enter inside the common casing 403. The motor cartridge 402 may be bolted into the common casing 403 via bolts 4021 and 4022 that align with bolt holes 4031 and 4032, respectively. Two or more bolts may be used. Other methods of fastening may also be used. The compressor cartridge 401 is configured, for example, to completely enter inside the common casing 403.

Shafts 409 and 410 of the compressor cartridge 401 and the motor cartridge 402 may be connected to each other by a Hirth connection 404A and a pin 404B. A Hirth connection is used to connect two pieces of a shaft together and is characterized by teeth that mesh together on the end faces of each half shaft. In other embodiments, other connectors between the shafts of the centrifugal compressor cartridge 401 and the motor cartridge 402 may be used as long as the connection may be connected or disconnected without the need of maintenance personnel to enter inside the common casing 403. Such connections may be a magnetic connector or a flexible connector or a Hirth connection or a flange or others types of connections known in the art.

In one exemplary embodiment, there are one or more sets of magnetic bearings 408. The magnetic bearings 408 permit relative motion with very low friction and/or mechanical wear. Also, because magnetic bearings do not require lubricants, there is no risk of contamination from the lubricants, and there is no need to replenish said lubricants. The internal surfaces of the common casing 403 are preferably configured to permit the sliding of the motor cartridge 402 and the compressor cartridge 401 in opposite directions during the installation phase. FIG. 4 further shows the compressor shaft 409, the motor shaft 410, and shoulders 412A and B provided inside the common casing 403 for providing a stop position for the compressor and motor cartridges 401 and 402. In an application, a fan 414 is provided on the motor shaft 410 for driving a cooling gas coming from a duct 416 for cooling various parts of the motor cartridge 402. In another application, an internal diameter D1 of the common casing 403 corresponding to the motor cartridge 402 is larger than an internal diameter D2 of the common casing 403 corresponding to the compressor cartridge 401 or vice versa.

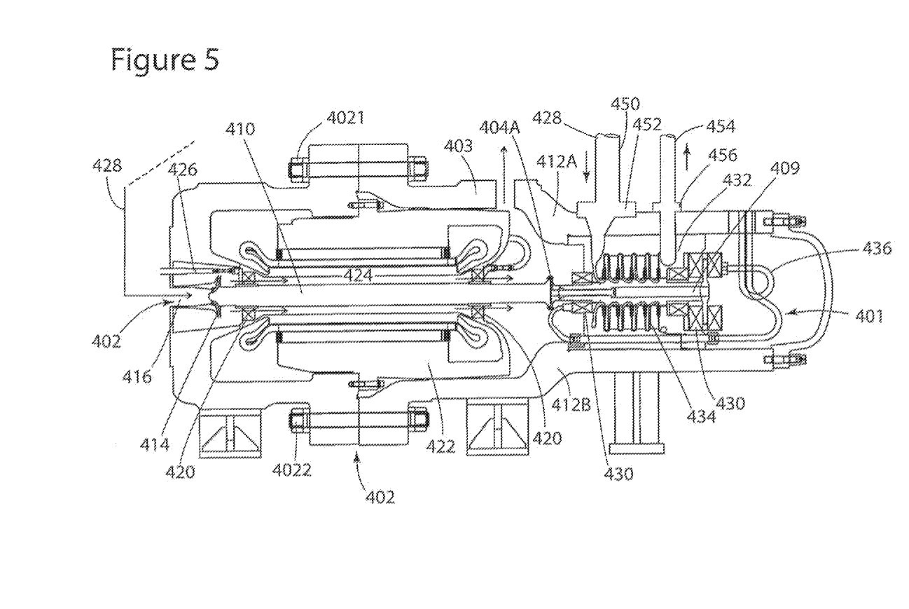

FIG. 5 is a schematic of a compressor and a motor where the compressor cartridge 401 and the motor cartridge 402 are connected together and to the common casing 403. It is noted that by having the entire components of the compressor assembled in the compressor cartridge 401 and similar for the motor, the assembly and disassembly of the compressor and/or motor is quick as the entire cartridge is removed when a part has failed and a new cartridge may be inserted to quickly bring the plant or other facility back online.

FIG. 5 shows further details of the motor compressor assembly 400. The motor cartridge 402 includes the motor shaft 410, magnetic bearings 420 configured to support the motor shaft 410, motor supports 422, a motor statoric part 424 and electric wirings 426 configured to provide electric power to the magnetic bearings 420 and other components of the motor cartridge. As discussed with reference to FIG. 4, the motor cartridge may include a fan 414 attached to an end of the motor shaft 410 and configured to drive a cooling fluid from the duct 416 for cooling the motor. The fluid, e.g., gas processed by the compressor cartridge 401, may be provided from a pipe 428 that is discussed later.

Turning to the compressor cartridge 401 shown in FIG. 5, it is noted that the compressor cartridge includes the compressor shaft 409, magnetic bearings 430 configured to support the compressor shaft 409, a compressor bundle 432 (that may include the motor shaft and all the statoric diaphragms of the compressor), compressor diaphragms and diffusers 434, and compressor and bearings electric wiring 436 for supplying electrical power and/or data to various components of the compressor. This figure also shows how the compressor cartridge 401 and the motor cartridge enter inside the common casing 403, at least partially. Further, it is noted that both cartridges are configured to slide inside the common casing 403, for example, on wheels incorporated either in the common casing or in the cartridges. Shoulders 412A and B are configured to stop the sliding of the two cartridges toward each other. The compressor cartridge is configured to also slide during operation, due to thermal expansion. After this assembly phase, when the cartridges are in place, both cartridges are fixed to the common casing 403. For example, FIG. 5 shows that the motor cartridge 402 has its own external casing 402A that is configured to be attached to the common casing 403, for example, by bolts 4021 and 4022. In one application, the compressor cartridge (401) does not have an external casing as the entire compressor cartridge enters inside the common casing 403. A cover 401A is attached to the common casing 403 for closing the compressor cartridge 401 inside the casing.

The compressor cartridge 401 is configured to have an inlet duct 450 that is configured to be connected to an upstream gas supply for providing the gas to an inlet 452 of the common casing 403 that feeds the compressor. The compressor cartridge 401 also has an outlet duct 454 that is configured to be connected to a downstream gas pipe. The outlet duct 454 is connected to an outlet 456 of the common casing 403 that receives the pressurized gas from the compressor. Pipe 428 may be connected to the inlet duct 450 or the outlet duct 454 for providing gas for cooling parts of the motor.

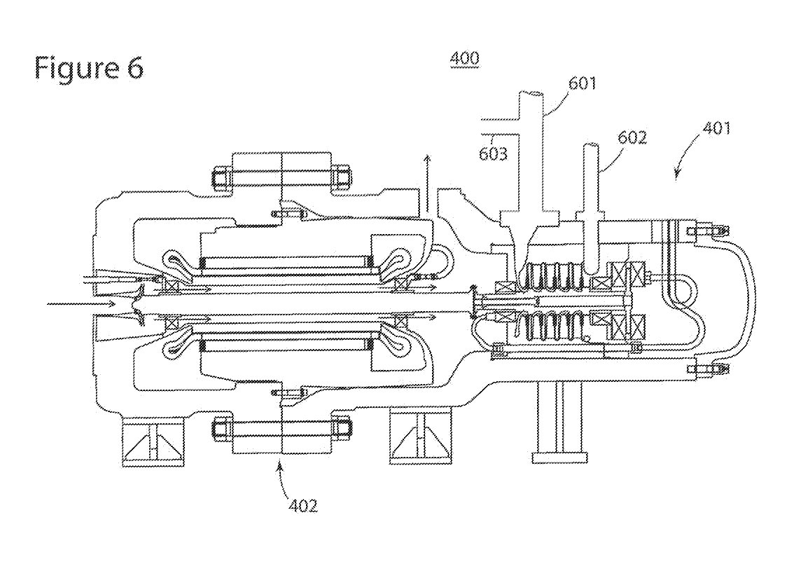

In an exemplary embodiment shown in FIG. 6, a gas inlet 601 and a gas outlet 602 to the centrifugal compressor cartridge 401, as well as a gas port 603 to the motor cartridge 402 are shown. Gas port 603 provides compressed gas from the gas inlet 601 to the motor within the motor cartridge 402, where the gas expands thereby cooling the motor. Alternatively, a fan may be used as shown in FIG. 5. The used gas is then returned to the compressor.

Advantages of the modular permanent magnetic motor compressor system shown in FIGS. 4-6 include, but are not limited to, a) a shorter assembly/disassembly time; b) simplified coupling/decoupling of the compressor and motor; c) high level of standardization relative to the common casing; d) a smaller overall footprint of the system; and e) easier checking of the cartridges before assembly within the common casing. Also, unlike the related art described above, the modular permanent magnetic motor compressor system shown in FIGS. 4-6 does not require a retractable port to facilitate connecting/disconnecting the cartridges, thus improving the structural integrity of the overall system.

The turbomachine shown in FIGS. 4-6 may operate with an inlet pressure range of 0-100 bar; outlet pressure range of 150-350 bar; unit power range of 2-10 Megawatts. The novel machine may be a multiple staging machine. Therefore, this machine may achieve different inlet or outlet pressure ranges or power ranges, e.g., extremely high output pressures greater than 350 bar. In other stage configurations, other pressure and horsepower ratings are possible.

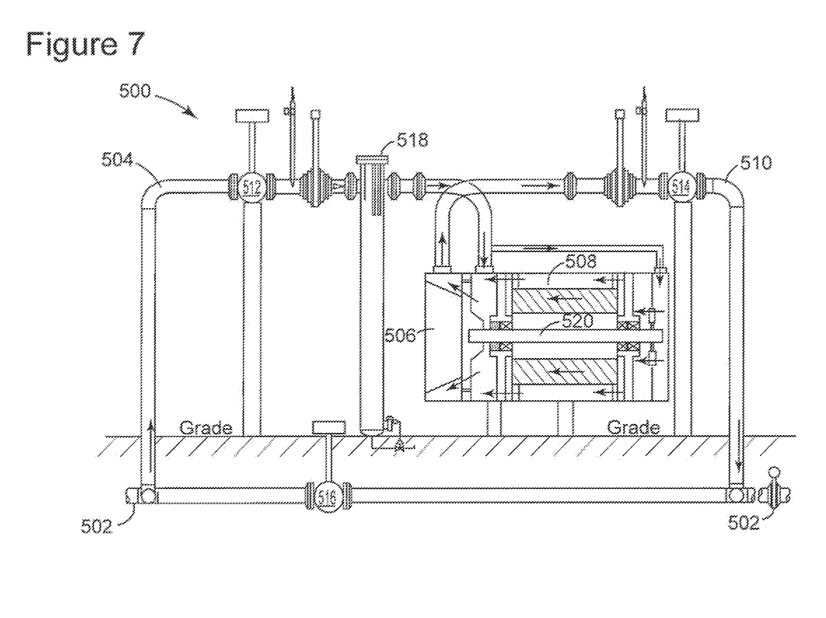

FIG. 7 is an exemplary embodiment of a gas compressing station 500. A gas pipeline 502 is coupled to a suction header 504 that enables gas flow into a gas compressor 506 powered by a motor 508. Gas entering compressor 506 is compressed and returned to pipeline 502 via a discharge header 510. A compressor inlet blocking valve 512 and an outlet blocking valve 514 facilitate control of compressor 506. A bypass header 516 includes a compressing station bypass blocking valve. A scrubber 518 is coupled in flow communication in suction header 504 to facilitate removing contaminants from the gas prior to gas introduction into compressor 506. In one embodiment, compressor 506 and motor 508 are coupled to a common compressor/motor shaft 520, In another embodiment, compressor 506 and motor 508 are connected by a Hirth connection and pin as shown in FIGS. 4-6.

Gas flows from pipeline 502 through station 500 as illustrated by the arrows included in FIG. 7. Suction header 504 channels gas to compressor 506 based on the relative positions of blocking valve 512, blocking valve 514, and blocking valve 516. For example, blocking valves 512 and 514 are normally open to permit gas flow through station 500. Gas subsequently flows into compressor 506 and is compressed to a greater density and smaller volume. Motor 508 drives compressor 506 via common shaft 520. Compressed gas exits compressor 506 through discharge header 510. Valves 512 and 514 may be closed to isolate components, such as scrubber 518, compressor 506 and/or motor 508 during maintenance operations.

Compressor 506 includes at least one stage of compression that increases a pressure of gas flowing therethrough. Compressor 506 includes: a housing with an inner surface and an outer surface, the inner surface defining a cooling plenum and a compressor intake plenum. There may also be a gas supply header coupled to the discharge header 510 such that a portion of the outlet gas flow is diverted to the motor 508 for cooling via expansion within the motor 508. If the motor 508 includes a gas turbine and a combustor, the booster may include a gas supply header coupled to the suction header 504 such that a portion of the inlet gas flow stream upstream from the housing outer surface is diverted from the suction header and is channeled to the gas turbine as a fuel source.

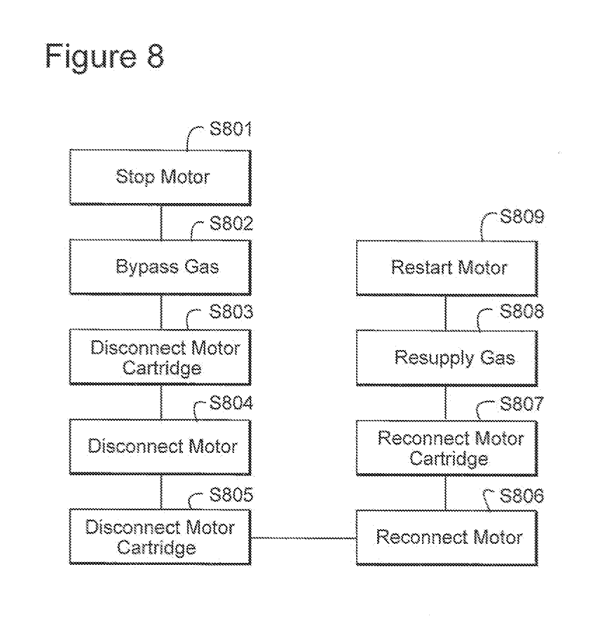

FIG. 8 is a flow chart of an exemplary method of the invention for repairing a motor compressor system including compressor cartridge including a centrifugal compressor, the system also including a motor cartridge including a motor, the system configured to receive a gas, compress the gas, and eject the compressed gas. The method includes: turning off the motor S801; bypassing the gas around the system S802; disconnecting the motor from the compressor S804 by disconnecting a birth connector connecting the motor to the compressor S803; and disconnecting and removing the motor cartridge from the casing S805. The method may further include: reconnecting the motor within the motor cartridge (or a replacement motor in the same or difference motor cartridge) to the compressor S806; reconnecting the motor cartridge to the casing S807; resupplying the gas to the booster S808; and starting the motor S809. The same steps may be applied for connecting and/or disconnecting the compressor from

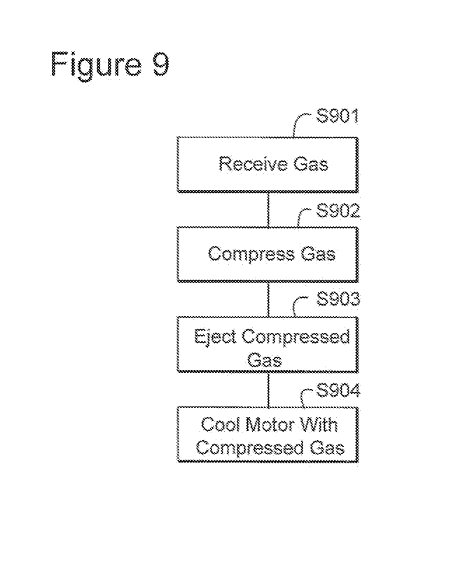

FIG. 9 is a flow chart of an exemplary method of the invention for transporting gas through a pipeline. The method includes: receiving the gas into a motor compressor system from a first section of the pipeline at a first pressure S901, the system including a compressor driven by a motor having permanently magnetized bearings; compressing the gas with the centrifugal compressor S902; and ejecting the compressed gas to a second section of the pipeline at a second pressure higher that the first pressure S903. Here, the system includes a common casing, a motor cartridge housing the motor and detachably connected to the common casing, and a compressor cartridge detachably connected to the common casing and housing the compressor, the compressor detachably connected to the motor via a hirth connector. The method may further include cooling the motor with the compressed gas S904.

An advantage of one or more embodiments discussed above is that the turbomachine is simple to upgrade while being part of the plant as the upgrade include replacing the compressor or motor cartridge of the novel machine with a new one in order to better match the changed plant needs.

The disclosed exemplary embodiments provide a motor compressor system that includes self-contained compressor cartridge connectable to a self-contained motor cartridge, the compressor cartridge and the motor cartridge each configured to be installed in a common casing. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A motor compressor system in which the motor is configured to activate the compressor, the system comprising:
a common casing;
a motor cartridge housing a motor, the motor cartridge detachably placed inside the common casing; and
a compressor cartridge housing a compressor detachably connected to the motor, the compressor cartridge detachably placed inside the common casing.

2. The system of claim 1, further comprising:
a motor shaft configured to drive the motor;
a compressor shaft configured to drive the compressor;
a mechanical joint configured to connect the motor shall to the compressor shaft within the common casing, wherein the mechanical joint is one of a Hirth connector or a magnetic connector or a flexible connector.

3. The system of claim 1, wherein the entire compressor is within the compressor cartridge and the entire motor is within the motor cartridge.

4. The system of claim 1, wherein the motor cartridge and/or the compressor cartridge are configured to slide inside the common casing at least during an assembly phase, and the motor cartridge and/or the compressor cartridge are rigidly coupled inside the common casing at the end of the assembly phase.

5. The system of claim 1, further comprising:
an inlet duct configured to be connected to an upstream gas supply pipe and configured to supply gas to an inlet of the common casing; and
an outlet duct configured to be connected to a downstream gas supply pipe and configured to supply gas from an outlet of the common casing.

6. The system of claim 5, further comprising:
a pipe configured to connect the downstream gas supply pipe or the upstream gas supply pipe to a motor inlet duct of the motor cartridge so as to provide the gas to cool the motor.

7. The system of claim 1, wherein there is no retractable cover between the compressor cartridge and the motor cartridge.

8. A motor cartridge system, comprising:
a motor cartridge configured to be detachably provided inside a common casing; and
a motor housed within the motor cartridge and configured to be detachably connected to a compressor, the compressor configured to compress gas.

9. The motor cartridge system of claim 8, further comprising:
a mechanical joint configured to connect a motor shaft to a compressor shaft within the common casing, wherein the mechanical joint is one of a Hirth connector or a magnetic connector or a flexible connector.

10. The motor cartridge system of claim 8, wherein the motor includes magnetic bearings.

11. The motor cartridge system of claim 8, further comprising:
a pipe configured to connect a downstream gas supply pipe or an upstream gas supply pipe to a motor inlet duct of the motor cartridge so as to provide the gas to cool the motor.

12. A motor compressor system in which a motor is configured to activate a compressor, the system comprising:
a common casing;
a motor cartridge housing the motor, the motor cartridge detachably provided inside the common casing;
a compressor cartridge housing the compressor detachably connected to the motor, the compressor cartridge detachably provided inside the common casing;
a mechanical connector connecting a motor shaft of the motor to a compressor shaft of the compressor within the common casing;
magnetic bearings provided in the motor around the motor shaft; and
a pipe configured to connect a downstream gas supply pipe or an upstream gas supply pipe connected to the common casing to a motor inlet duct of the motor cartridge so as to provide the gas to cool the motor.

14. The system of claim 12, wherein the compressor is a centrifugal compressor.

15. A method of repairing a system including a compressor cartridge having a compressor, the system also including a motor cartridge having a motor, the system configured to receive a gas, compress the gas, and eject the compressed gas, said method comprising:
turning off the motor;
closing or bypassing a gas flow through the compressor;
disconnecting the motor from the compressor by disconnecting a mechanical joint connecting a motor shaft of the motor to a compressor shaft of the compressor; and
disconnecting and removing the motor cartridge and/or the compressor cartridge from the common casing, wherein the compressor cartridge and the motor cartridge are provided inside the common casing.

16. The method of claim 15, further comprising:
sliding the motor cartridge inside the common casing;
reconnecting the motor to the compressor;
resupplying the gas to the compressor; and
starting the motor.

17. The method of claim 15, further comprising:
sliding a replacement motor cartridge inside the common casing;
connecting a replacement motor in the replacement motor cartridge to the compressor;
resupplying the gas to the compressor; and
starting the replacement motor.

18. A method of compressing gas, the method comprising:
receiving the gas into a motor compressor system from a pipeline duct at a first pressure, the motor compressor system including a compressor driven by a motor having magnetic bearings;
compressing the gas with the compressor; and
ejecting the compressed gas to an output pipeline at a second pressure higher that the first pressure,
wherein the motor compressor system includes a common casing, a motor cartridge housing the motor and detachably provided inside the common casing, and a compressor cartridge detachably provided inside the common casing and housing the compressor, the compressor detachably connected to the motor via a mechanical connector.

19. The method of claim 17, further comprising:
diverting at least part of incoming gas to cool the motor.

20. The method of claim 17, wherein the common casing is a single piece.
